(19) United States
(12) Patent Application Publication
(10) Pub. No.: US 2011/0284522 A1
(43) Pub. Date: Nov. 24, 2011

(54) QUICK-DISCONNECT USB-DRIVEN CERAMIC ELECTRIC HEATING APPARATUS

(76) Inventors: CHEN-HUAN HSIEH, Taipei (TW); Wen-Ying Fu, Taipei (TW)

(21) Appl. No.: 12/782,717

(22) Filed: May 19, 2010

(51) Int. Cl. H05B 3/08

(52) U.S. Cl. 219/541

(57) ABSTRACT

A quick-disconnect USB-driven ceramic electric heating apparatus includes a round base, a circuit board and a heating element. The round base is provided with a USB socket for receiving an external USB-based power supply that supplies power so as to have advantageous of power saving and low heat generation. The round base has a plurality of elastic barbed latches that allow the round base to be inlaid to holes of different sizes on ceramic devices. The heating element is a heater in form of flexible film and has an adhesive surface for adhering the heating element to the ceramic product so as to provide quick and direct heating to a specific portion of the ceramic device.

### BACKGROUND OF THE INVENTION

1. Technical Field

The present invention relates to electric heating apparatuses, and more particularly to a USB-driven ceramic electric heating apparatus that can be quickly connected to or disconnected from a round hole and is powered by a power supply connected to a USB socket thereof so as to directly heat a ceramic product.

2. Description of Related Art

Aromatherapy, as a natural treatment originating from Egypt and prevailing over Europe, uses various kind of essence extracted from plants as media to directly contact skin or to be absorbed by human for the purposes of relaxing mental pressure and improving physical health. Since essence is a substance with significant aromaticity, high volatility and high consistency, a heating apparatus is typically needed for presenting the effects of essence. A commercially available essence electric vaporizer includes at least a power supply, a circuit board, a heating element and a disk for receiving essence. When such essence electric vaporizer heats a disk filled with essence for a period, the essence is heated and vaporizing with an accelerated manner. The disk is typically made of ceramics so as to be resistant to wear, corrosion, high temperature and high pressure. However, the fragility of ceramics means that the essence electric vaporizer has to be handled and placed with care for fearing damage. Besides, after long-term use or when a user forgets to turn off the essence electric vaporizer after use, the risk of scalds emerges. Furthermore, in manufacturing the essence electric vaporizer, it is typical that the ceramic product and the heating apparatus are separately made, and then the ceramic product is formed with a hole for the heating apparatus to be inlaid therein, followed by fixing the heating apparatus firmly to the ceramic product with an adhesive or screws. Thus, the existing essence electric vaporizer is difficult to disassemble. Consequently, when either the ceramic product or the heating apparatus fails, repair or replacement of elements is relatively difficult.

### SUMMARY OF THE INVENTION

One objective of the present invention is to provide a quick-disconnect USB-driven ceramic electric heating apparatus, which has a round base formed with a plurality of elastic barbed latches to be readily coupled with a hole preformed on a ceramic product, thereby achieving easy connection.

Another objective of the present invention to provide a quick-disconnect USB-driven ceramic electric heating apparatus, which has a heating element being a heater in form of flexible film, so as to remain fitting to a ceramic product as a surface curvature of the ceramic product changes, wherein the heating element has an adhesive surface to easily attach the heating element to a heating portion of a ceramic product.

Another objective of the present invention to provide a quick-disconnect USB-driven ceramic electric heating apparatus, which has a USB socket provided on a round base thereof for connecting an external power supply that supplies power required by heating, wherein the used USB technology facilitates achieving purposes of power saving due to the low power output and portability that contributes to convenient use of the apparatus.

### BRIEF DESCRIPTION OF THE DRAWINGS

The invention as well as a preferred mode of use, further objectives and advantages thereof will be best understood by reference to the following detailed description of an illustrative embodiment when acquire in conjunction with the accompanying drawings, wherein:

FIG. 1 is a perspective view of the present invention;

FIG. 2 is a schematic partial drawing of the present invention;

FIGS. 3 through 5 illustrate an application of the present invention.

### DETAILED DESCRIPTION OF THE INVENTION

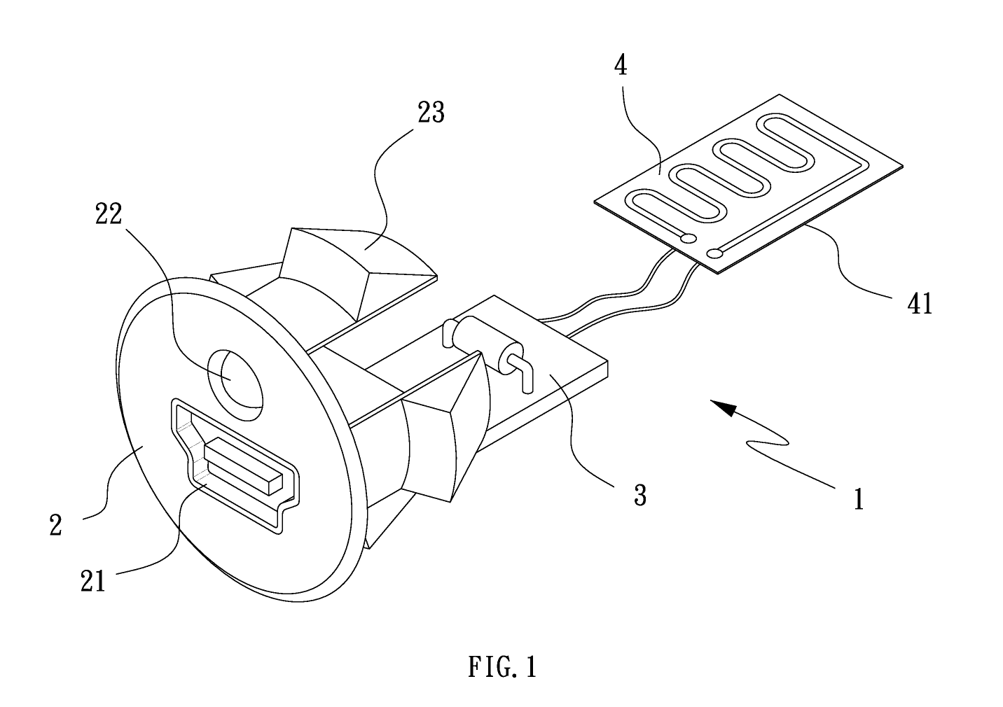

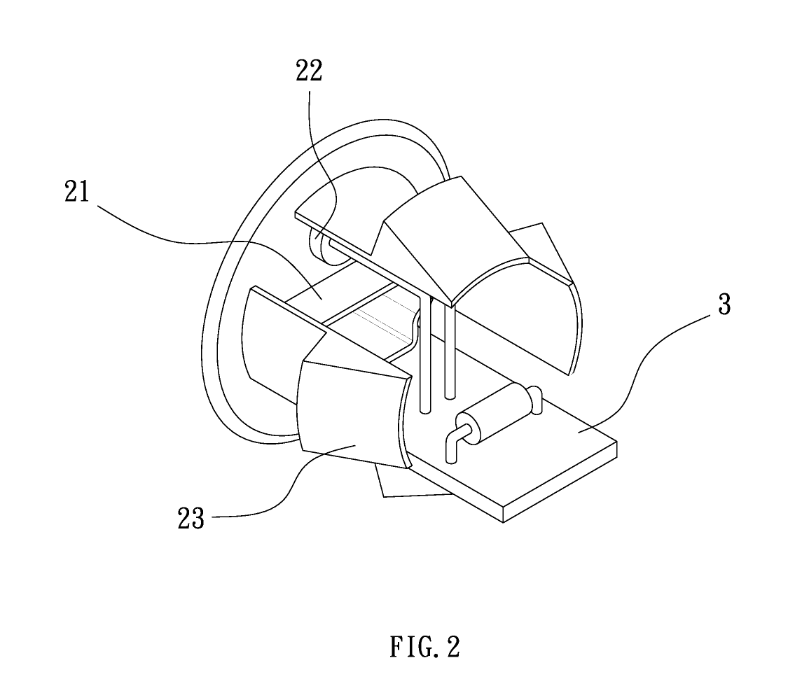

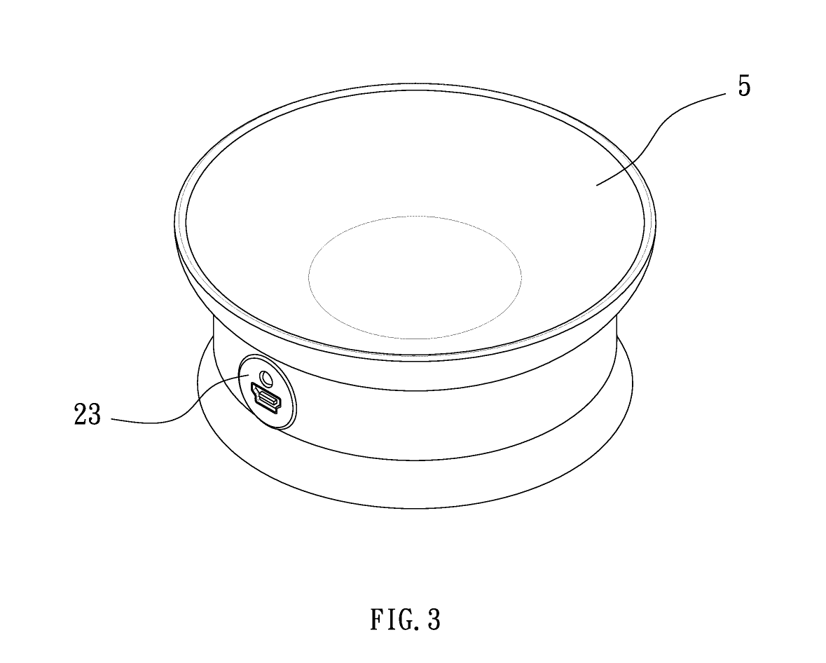

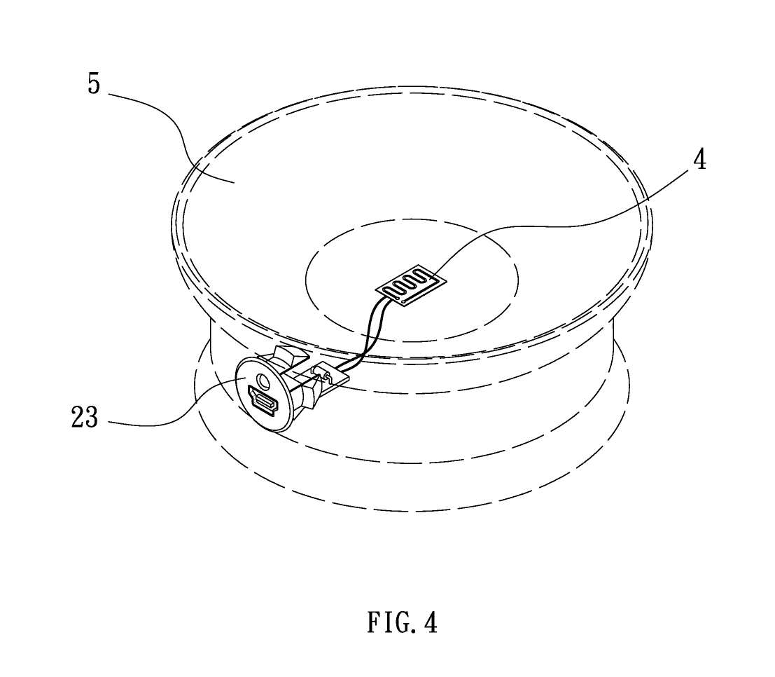

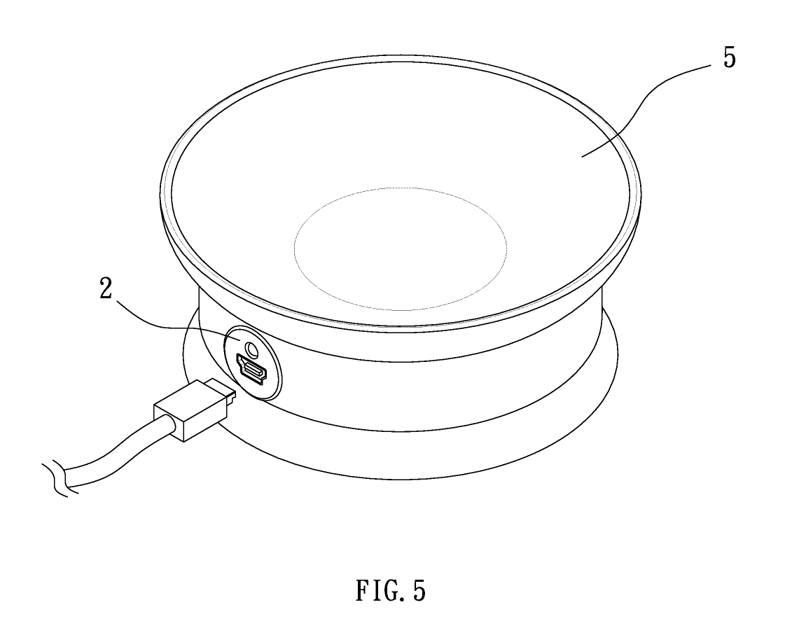

Please refer to FIG. 1, FIG. 2, FIG. 3, FIG. 4 and FIG. 5 for a perspective view, a schematic partial drawing and applied views of the present invention. As shown, the quick-disconnect USB-driven ceramic electric heating apparatus 1 primarily comprises a round base 2, a circuit board 3 and a heating element 4.

The round base 2 has a plurality of elastic barbed latches 23. The round base 2 has a reverse side centrally inlaid with a USB socket 21 and there is a light-emitting element 22 set above the USB socket 21.

The circuit board 3 carrying relevant electronic components is attached to the round base 2 amid the elastic barbed latches 23.

The heating element 4 is a heater in form of flexible film electrically connected to the circuit board 3 and has a conducting wire extending outward the circuit board 3. One side of the heating element 4 is configured to be an adhesive surface 41 for adhering to and heating a ceramic product 5.

To assemble the quick-disconnect USB-driven ceramic electric heating apparatus 1 with the ceramic product 5 for use, the round base 2 is placed into a hole in a peripheral wall of the ceramic product 5 with the elastic barbed latches 23 coupled with a periphery of the hole. The elastic barbed latches 23 are adaptive to ceramic products with peripheral holes of different sizes so as to firmly fix the round base 2 to the ceramic product 5. The round base 2 is such inlaid that the USB socket 21 and the light-emitting element 22 are exposed outside the ceramic product 5.

Afterward, the heating element 4 has the adhesive surface 41 adhered to a lower surface of a heating portion inside the ceramic product 5. In use, the USB socket 21 receives an external power supply for powering the electronic elements on the circuit board 3 to drive the heating element 4 to heat the ceramic product 5. The light-emitting element 22 serves to indicate an established electric connection between the USB socket 21 and the external power supply.

In the embodiment shown in the drawings, the quick-disconnect USB-driven ceramic electric heating apparatus 1 is applied to the ceramic product 5 of an electronic essence stove. The heating element 4 is adhered to the essence stove below the heating portion that receives essence, so the essence heated by the heating element 4 can give fragrance to the ambient air. The quick-disconnect USB-driven ceramic electric heating apparatus 1 of the present invention is applicable to, in addition to electronic essence stoves, any heating device with such ceramic product 5, e.g. a ceramic cup warmer, a ceramic dining utensil or a ceramic warning pot.

1. A quick-disconnect USB-driven ceramic electric heating apparatus, comprising:
a round base having a plurality of elastic barbed latches extending from one side thereof and being configured to be fixed on a round hole formed on a peripheral wall of a ceramic product;
a USB socket deposited on a center of a reverse side of the round base reverse to the side having the elastic barbed latches for receiving an external power supply;
a circuit board carrying relevant electronic components and being attached to the round base amid the elastic barbed latches; and
a heating element electrically connected to the circuit board and having a side formed as an adhesive surface for adhering to the ceramic product for heating;
whereby the elastic barbed latches allow the round base to be readily inlaid into the round hole of the ceramic product, and the adhesive surface allows the heating element to be attached below the ceramic product, while the USB socket receives the external power supply to power the heating element to heat.

2. The quick-disconnect USB-driven ceramic electric heating apparatus of claim 1, wherein the elastic barbed latches are made of an elastic material and the elastic material is rubber, PE foam, EVA foam or PU foam.

3. The quick-disconnect USB-driven ceramic electric heating apparatus of claim 1, wherein a light-emitting element is provided on the round base and near the USB socket for indicating an established electric connection between the USB socket and the external power supply.

4. The quick-disconnect USB-driven ceramic electric heating apparatus of claim 1, wherein the heating element is a heater in form of flexible film so as to remain fitting to the ceramic product as a surface curvature of the ceramic product changes.

5. The quick-disconnect USB-driven ceramic electric heating apparatus of claim 4, wherein the heater has a conducting wire extending outward the circuit board.
